(19) United States
(12) Patent Application Publication
(10) Pub. No.: US 2003/0036909 A1
(43) Pub. Date: Feb. 20, 2003

(54) Methods and devices for operating the multi-function peripherals

(76) Inventor: Yoshinaga Kato, Yokohama-shi (JP)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/223,181

(22) Filed: Aug. 19, 2002

(30) Foreign Application Priority Data
Aug. 17, 2001 (JP) 2001-247587

(51) Int. Cl. G10L 11/00

(52) U.S. Cl. 704/275

(57) ABSTRACT

An interface device interfaces a visually impaired with a multi function machine primarily based upon an audio input and an audio output. Once the interface device identifies the use of the multi function machine by the visually impaired, the interface device switches the operation mode of the multifunction machine from the normal operation mode to the audio operation mode so that the interface is primarily through audio inputs and outputs. Based upon the audio inputs and outputs, the visually impaired operator is able to navigate through a multi-layered menu to select and specify operational items and conditions.

### FIELD OF THE INVENTION

The current invention is generally related to multi-function peripherals, and more particularly related to methods, programs and devices for the visually impaired to operate the multi-function peripherals.

### BACKGROUND OF THE INVENTION

Multi-function peripherals (MFP) perform a predetermined set of combined functions of a copier, a facsimile machine, a printer, a scanner and other office automation (OA) devices. In operating a sizable number of functions in a MFP, an input screen is widely used in addition to a keypad. The screen display shows an operational procedure in text and pictures and provides a designated touch screen area on the screen for inputting a user selection in response to the displayed operational procedure.

It is desired to improve an office environment for people with disability so that these people can equally contribute to the society as people without disability. In particular, the section 508 of the Rehabilitation Act has become effective on Jun. 21, 2001 in the United States, and the federal government is required by law to purchase information technology related devices that are usable by people with disability. State governments, related facilities and even private sectors appear to follow the same movement.

Despite the above described movement, the operation of the MFP is becoming more and more sophisticated. Without displaying instructions on a display screen or a touch panel, it has become difficult to correctly operate the MFP. Because of the displayed instructions, the operation of the MFP has become impractical for the visually impaired. For example, when a visually impaired person operates a MFP, since he or she cannot visually confirm a designated touch area on a screen, the operation is generally difficult. For this reason, the visually impaired must memorize a certain operational procedure as well as a touch input area on the screen. Unfortunately, even if the visually impaired person memorizes the procedure and the input area, when the operational procedure or the input area is later changed due to future updates or improvements, the current memorization becomes invalid.

One prior art improved the above described problem by providing audio information for the visual information when a MFP is notified of the use by a visually impaired person. The visually impaired person indicates to the MFP by inserting an ID card indicative of his or her visual disability or inserting an ear phone into the MFP. The audio information is provided by a voice generation device. Alternatively, tactile information is provided by a Braille output device.

An automatic teller machine (ATM) is also equipped with a device to recognize a visually impaired person when either a predetermined IC card or a certain ear phone is inserted in the ATM. In order to withdraw or deposit money into his or her own account, the instructions are provided in Braille or audio when the ATM recognizes that a visually impaired person is operating. An input is through a keyboard with Braille on its surface.

Unfortunately, based upon a ratio of the disabled population to the normal population, the extra costs associated with the above described additional features for the disabled are prohibitive to make every user machine equipped with the additional features. Furthermore, if a mixture of the ATMs exists with and without the handicapped features, the users probably will be confused.

For the above reasons, it remains desirable to provide devices or machines that are cost effective and easy to use by the visually impaired.

### SUMMARY OF THE INVENTION

In order to solve the above and other problems, according to a first aspect of the current invention, a method of interfacing a visually impaired with a multi function machine, the multi function machine having an audio operation mode and a normal operation mode, including the steps of: generating a layered menu having multiple layers, each layer having a predetermine number of operational items; identifying a use of the multi function machine by the visually impaired; switching an operational mode of the multi function machine from the normal operation mode to the audio operation mode upon identifying the use by the visually impaired; receiving a voice input with respect to the layered menu from the visually impaired in the audio operation mode; and responding to the voice input by an audio feedback to the visually impaired.

According to a second aspect of the current invention, an interface device for interfacing a visually impaired with a multi function machine, the multi function machine having an audio operation mode and a normal operation mode, including: a function control unit for identifying a use of the multi function machine by the visually impaired and for switching an operational mode of the multi function machine from the normal operation mode to the audio operation mode upon identifying the use by the visually impaired; an operational control unit connected to the function unit for controlling a user input and a user output; a voice input unit connected to the operational unit for inputting a voice input as the user input with respect to the layered menu in the audio operation mode; a menu control unit connected to the operational control unit for tracking a current position in a layered menu having multiple layers based upon the user input, each layer having a predetermine number of operational items; and a voice output unit connected to the operational unit for outputting an audio feedback in response to the user input.

According to a third aspect of the current invention, a recording medium for storing computer instructions for interfacing a visually impaired with a multi function machine, the multi function machine having an audio operation mode and a normal operation mode, the computer instructions performing the tasks of: generating a layered menu having multiple layers, each layer having a predetermine number of operational items; identifying a use of the multi function machine by the visually impaired; switching an operational mode of the multi function machine from the normal operation mode to the audio operation mode upon identifying the use by the visually impaired; receiving a voice input with respect to the layered menu from the visually impaired in the audio operation mode; and responding to the voice input by an audio feedback to the visually impaired.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a prospective view illustrating a preferred embodiment of the interface unit in a multi-function peripheral (MFP) according to the current invention.

FIG. 2 is a diagram illustrating an exemplary operational panel of the interface device according to the current invention.

FIG. 3 is a single table illustrating a first portion of one exemplary menu that is used in the interface device according to the current invention.

FIG. 4 is a single table illustrating a second portion of the exemplary menu that is used in the interface device according to the current invention.

FIG. 5 is a diagram illustrating a conceptual navigation path in a layered menu as used in the current invention.

FIG. 6 is a diagram illustrating a keypad used to select and move among the operational items in the layered menu.

FIG. 7 illustrates an exemplary tree structure that is generated in response to a keywords search.

FIG. 8 illustrates another exemplary tree structure.

FIG. 9 is a block diagram that illustrates one preferred embodiment of the interface device according to the current invention.

FIG. 10 is a diagram illustrating a second preferred embodiment of the interface unit in a multi-function peripheral (MFP) according to the current invention.

FIG. 11 is a flow chart illustrating steps involved in a preferred process of interfacing a visually impaired operator with a MFP according to the current invention.

### DETAILED DESCRIPTION OF THE PREFERRED EMBODIMENT(S)

Based upon incorporation by external reference, the current application incorporates all disclosures in the corresponding foreign priority document (JP2001-254779) from which the current application claims priority.

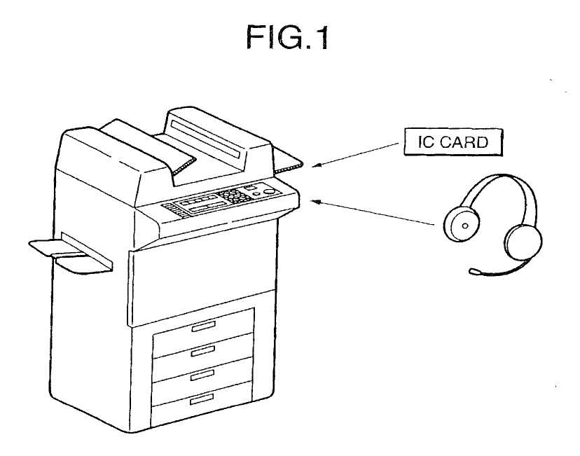

Referring now to the drawings, wherein like reference numerals designate corresponding structures throughout the views, and referring in particular to FIG. 1, a prospective view illustrates a preferred embodiment of the interface unit in a multifunction peripheral (MFP) according to the current invention. Although the interface unit will be described with respect to a digital MFP, the current invention is not limited to the use with MFP's and is applicable to devices that perform a plurality of various tasks.

A. Operational Overview of the Interface Device

In the following example, the operation is illustrated for copying an original. As shown in FIG. 1, the use by a visually impaired person is recognized upon inserting a head set with a microphone and earphones is inserted into a predetermined jack of a digital MFP. Alternatively, the use by a visually impaired person is recognized upon detecting a non-contact IC card that contains the past operational records. Upon the above detection, the MFP enters into au audio mode in which a visually impaired person operates. The MFP is generally in a regular mode in which a visually normal person operates. In the following description, the visually impaired operator is simply referred to as an operator in the voice mode.

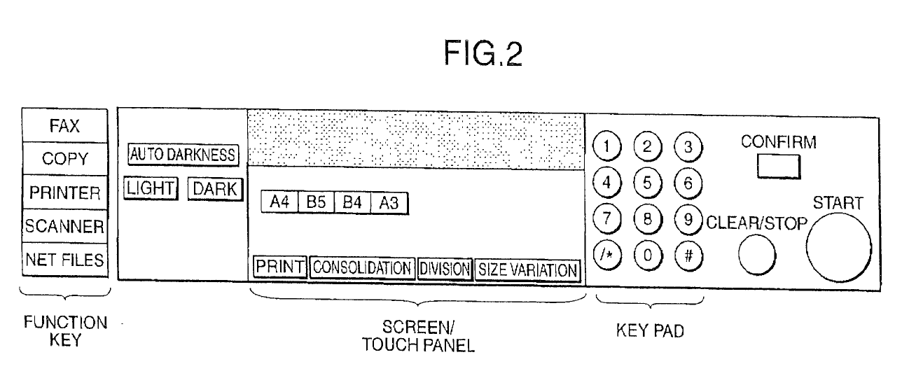

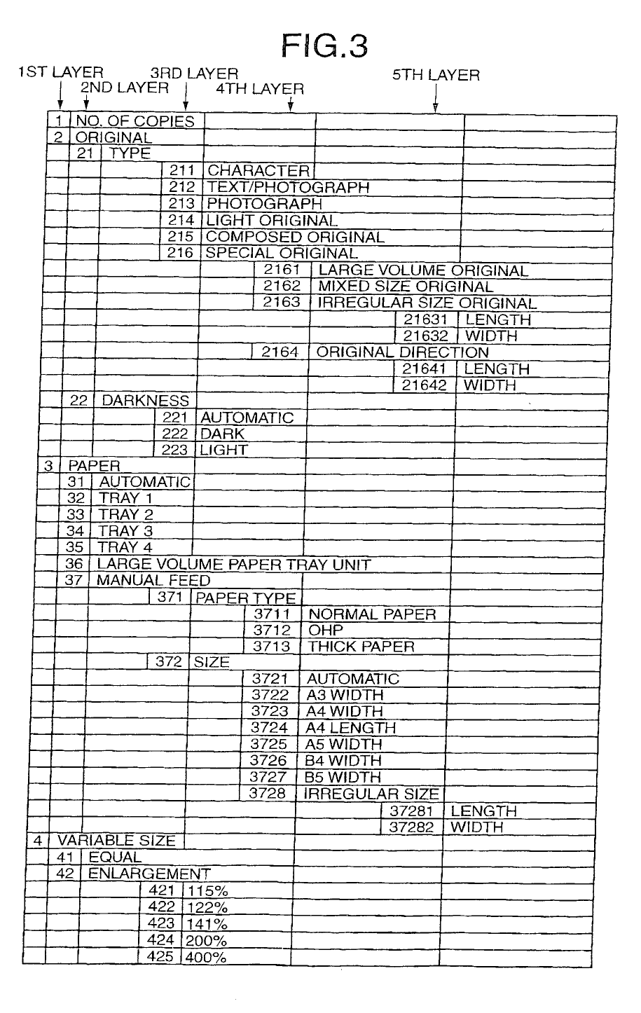

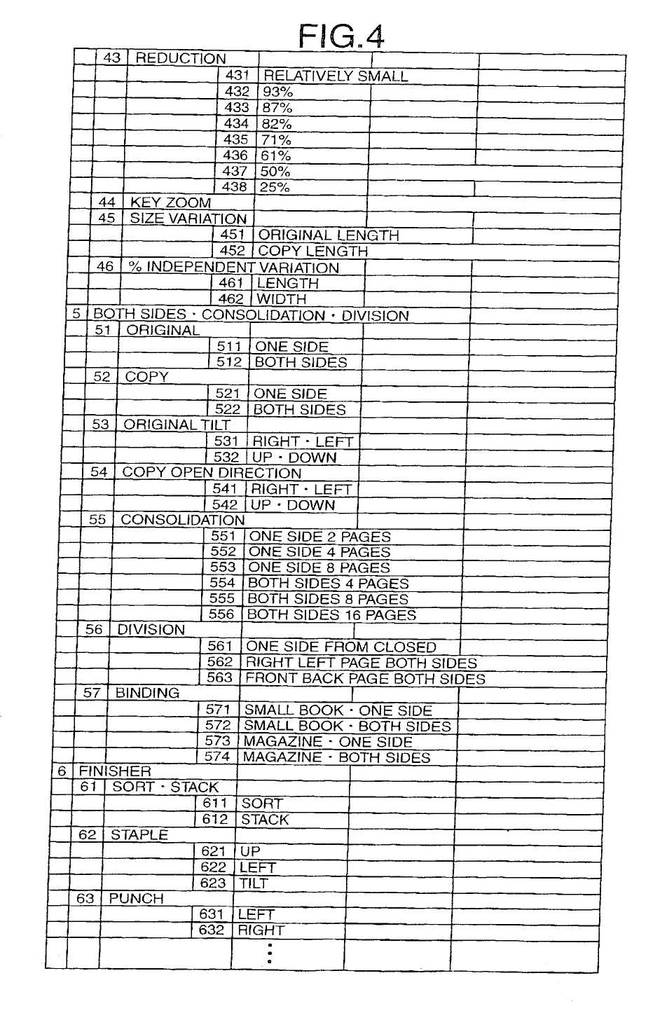

Now referring to FIG. 2, a diagram illustrates an exemplary operational panel of the interface device according to the current invention. After pressing the copy key on the left side in the audio mode, the interface device responds by outputting an audio message through the headset. The audio message states “a copy operation is ready.” The interface device consolidates frequently used operational items according to its applications such as a photocopier and a facsimile machine. The operational items are further grouped according to general and detailed functions. Thus, a single menu is created with a plurality of layers. For example, some functions of a photocopier are grouped into layers as shown in FIGS. 3 and 4.

Still referring to FIG. 2, the operator uses a key bad to navigate through the layers in the above described layered menu in order to reach a desired operational item. During the menu item selection, the interface device describes in audio the function of a selected item and the current setting, and the audio feedback includes the reading of the description, sound icons and back ground music (BMG). Furthermore, the audio feedback varies in rhythm, pitch and speed depends upon the operational item type, a processing status or a layer depth. Because of the above audio feedback, the operator is able to operate the complex procedure without viewing any information that is displayed in a touch panel screen or inputting information via the touch panel screen. After repeatedly navigating the menu to select a set of desired operational items, the operator presses a start key to initiate a photocopy of an original.

In addition to the above described operation in which a selected function is described to an operator in audio, when an operator announce a keyword, the interface searches operational items in a layer menu that contain the keyword and the operational help information. The interface device outputs the searched information in audio. The operator selects an appropriate operational item from the searched information.

Furthermore, the above described audio-based selection process approximately corresponds to the screen-panel based selection process. The audio selection process also allows the operator to input in parallel a selection by touching a predetermined area in devices such as the touch-screen panel and the keypad. The parallel input mode enables an operator without disability to help an operator with disability. The parallel input mode also allows a slightly visually impaired operator to input data through the audio mode and the regular mode.

B. Detailed Operation of the Interface Device

(1) Menu Structure

A single tree structure menu is constructed. Since it is difficult to remember a plurality of menus that corresponds to complex operational procedures which are displayed on the screen, a separate menu is generated for a different function and each menu is further layered. In other words, for each device such as a photocopier, a facsimile machine, a printer, a scanner and a NetFile device, a set of frequently used operational items is selected, and the operational items are grouped by the function. Within each of the functions, the operational functions are further grouped into more detailed functions. Based upon the above function menu generation, a single tree structure menu is generated to have multiple layers. For example, if the operational items such as “variable size” and “both sides” still have more detailed operational items, the detailed operational items are considered to be under a subgroup name. Under the subgroup of “variable size,” “equal duplication,” “enlargement,” “reduction” and so on are placed, and its further detailed items are set to be “115%,” “87%” and so on to be a final and single choice. Exemplary types in the above described layered menu include: a single selection type within the layer, a toggle selection type, a value setting type and an action type. One example of the single selection type is to select one from “115%” and “122%” items under the enlargement selection item. Similarly, one example of the toggle selection type is to select “ON” or “OFF” for sorting in a finisher. One example of the value setting type allows the operator to input a desired value for a number of copies to be duplicated via the keypad. Lastly, one example of the action type activates the generation of an address list that is stored in a facsimile machine.

Referring to FIGS. 3 and 4, a single table illustrates one exemplary menu that is used in the interface device according to the current invention. The exemplary menu for photocopying is layered from a first layer to a fifth layer. The first layer includes operational items such as a number of copies, original, paper, variable size, both sides/consolidation/division and finisher. Each of these operational items are further divided into the second and then into third layers. Each of these layers and the operational items has a corresponding number, and the corresponding number specifies a particular operational item without going through the layer selection. The corresponding number is called a function number.

(2) Menu Operational Method

To navigate the above described layered menu, referring back to FIG. 2, a diagram illustrates an operational unit of the interface device according to the current invention. The operational unit includes function keys, a display screen, a touch panel, a keypad, a start/stop key and a confirmation key. The function keys allow the operator to select a function from photocopying, faxing, printing, scanning, net filing and so on. The display screen displays the operational status and messages while the touch panel on the display screen allows the selection of various operational items. The keypad inputs numerical input data.

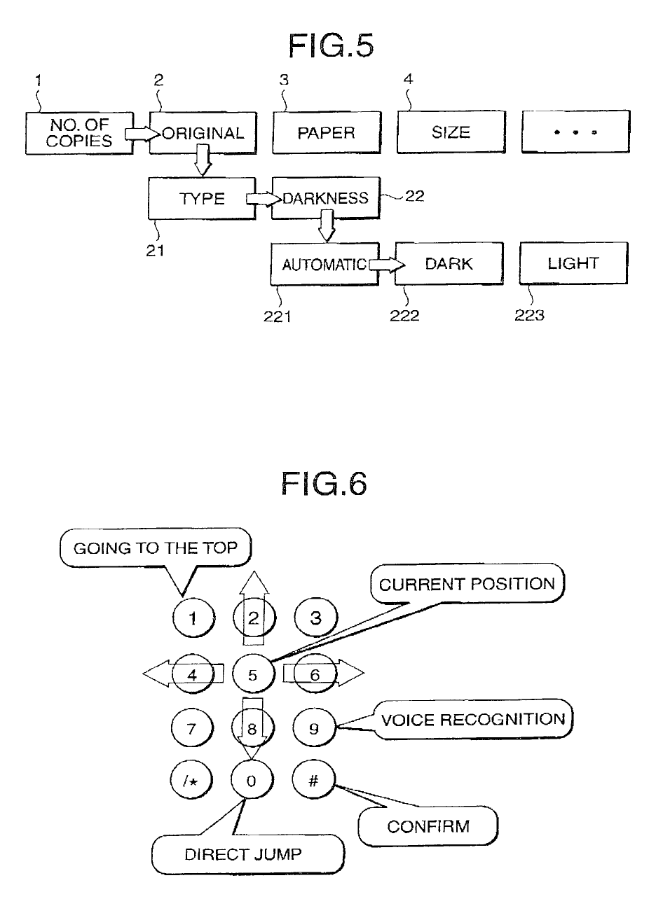

Referring to FIG. 5, a diagram illustrates a conceptual navigation path in a layered menu as used in the current invention. In the first layer of the layered menu as shown in FIGS. 3 and 4, there are predetermined operational items including a number of copies 1, original 2, paper 3, variable size or size 4 and so on. The reference numerals correspond to the numbers that are used in the layered menu table as shown in FIGS. 3 and 4. The first layer includes more operational items, but the diagram does not illustrate all of the operational items in the first layer. Within the first layer, the operator navigates among the operational items from the number of copies 1 to the original 2 as indicated by a horizontal arrow. After selecting the original 2, the operator goes down to a second layer under the original 2 to type 21 as indicated by a vertical arrow. Within in the second layer, the operator further navigates to a second operational item, darkness or a darkness level 22 as indicated by a second horizontal arrow. Lastly, the operator reaches the third layer from the second layer operational item, the darkness 22 as indicated by a second vertical arrow. The third layer includes operational items such as automatic 221, dark 222 and light 223. Within the third layer, the operator now moves from automatic 221 to dark 222. The navigation within the layered menu is thus illustrated by a series of the horizontal and vertical movements as indicated by the horizontal and vertical arrows.

Furthermore, the keypad is used to select and move among the operational items in the layered menu, and exemplary functions of the keys are shown in FIG. 6. In other words, the vertically positioned keys 2 and 8 are used to move vertically in the layers. Pressing the key 2 climbs the layer upward while the pressing the key 8 goes the layer downward. The horizontally positioned keys 4 and 6 are used to move horizontally among the adjacent operational items within the same layer. Pressing the key 4 goes to the left within the same layer while the pressing the key 6 goes to the right within the same layer. The directions are arbitrarily set in the above example and can be changed.

Still referring to FIG. 6, the movement of certain keys is further described.

When the operator indicates the downward movement to a lower layer and a plurality of operational items exists in the lower layer, one of the following predetermined rules is adapted to go to a next operational item. A first predetermined rule is to go to a first operational item in the lower layer. For example, when there is no previously entered value such as the case in selecting an original type, the downward key goes to the first operational item. A second predetermined rule is to go to a previously entered value or previously selected item in the lower layer. For example, when there is a previously selected item or entered value in the lower layer, the downward movement goes to the selected item for editing the value or a continuing item that is not the selected item. A third movement is to go to a predetermined default operational item in the lower layer. For example, operational items for setting darkness include “light,” “normal” and “dark,” and a predetermined default value is “normal.”

When the operator indicates a horizontal movement in a layer and the currently operational item is the last operational item within the same layer, the horizontal movement goes to a first operational item within the same layer in a circular manner. The same horizontal direction allows the operator to select a desired operational item within the same layer. However, if the operator does not know a number of the operational items with a particular layer, he or she may be lost within the layer. For this reason, an alternative horizontal key movement stops at the last operational item of the layer and does not allow further movement as in the above described circular movement. In this horizontal key movement, upon reaching the last operational item, the operator can track back in the opposite direction, and he or she can figure out a total number of operational items in the same layer.

Still referring to FIG. 6, additional keys will be further described. When the operator is lost in the layers of the menu, to go back to the initial selection position, a key 1 places the operator back in the top layer no matter where the current position is. In the example as shown in FIG. 3, the top layer or first layer is “a number of copies.” In returning to the first layer, the already selected operational items are stored in a predetermined memory, and the operator is able to go back to the already selected operational items by using the above described movement keys and a confirmation key. Another key such as a key 0 allows the operator to directly jump to a desired operational item. The key 0 allows the operator to input a number value which is the above described function number that corresponds to a corresponding operational item. For example, if the operator pressed the key 0 and inputs “435,” the interface device jumps to “71%” as if “variable size” and “reduction” items have sequentially been selected. Instead of the lowest or bottom operational item, t he function number of a middle layer is also inputted. When a middle layer is selected, a default operational item is selected in the selected middle layer, and the operator subsequently selects an operational item among the predetermined operational items of the specified middle layer.

In the audio mode, the operator initially presses a key 9 and pronounces a desired function number or a desired operational item so the current position jumps to the pronounced operational item. When the operator does not remember a desired function number or a desired operational item, the operator announces a certain term that expresses a desired function to the interface device. The interface device in turn performs a voice recognition procedure and searches an operational item that contains the voice recognized input word in the layered menu. If the search result contains a single hit, the interface device directly jumps to the searched operational item. For example, assuming that the layered menu contains “both sides, consolidation, division”→“bound book”→“single side from magazine,” when the operator announces “magazine,” the current position jumps to “single side from magazine” regardless of the present position. On the other hand, the voice recognized input is not found, the voice recognized input is used as a keyword to search in a predetermined operational help file. The audio information that corresponds to the search result is provided for further guidance. The operator selects an operational items based upon the guidance.

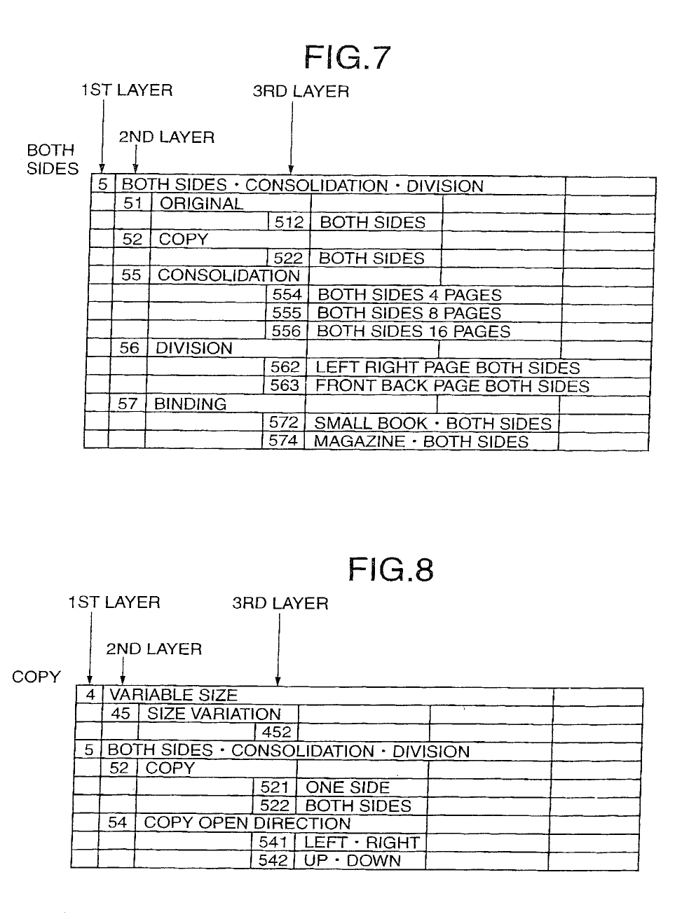

The operational help information is organized in the following manner. The operational items are divided into groups based upon their functions, and a set of keywords is provided to each associated with the groups. In the search, the inputted keyword is searched among the keywords associated with the groups to find a corresponding operational item. Each path between the operational item containing the keyword and an operational item in a corresponding top layer is isolated, and the isolated paths together form a new group in a tree-structured menu. Thus, the newly generated tree-structured group forms a portion of the layered menu that contains the keyword. For example, referring to a table in FIG. 4, under the layer, “both sides, consolidation, division,” functions that contain the keyword, “both sides” include “original,” “copy,” “consolidation,” “division” and “bound book.” Under each of these functions, an operational item includes the keyword, “both sides.” FIG. 7 illustrates a tree structure that is generated in response to the keyword search for “both sides.” Although the function containing the keyword, “copy” exists under the layer of “both sides, consolidation, division,” the function is not a bottom operational item at the terminal. In this case, the operational items are included till the bottom layer is encountered, and the incorporated tree structure appears as one as shown in FIG. 8.

The above operational support information includes the tree structure information and the voice/audio information and is recorded in either of the following formats. In the recorded voice data format, the recorded data is played back to the operator. In the compressed voice data format, voice data is compressed by a compression method such as code excited linear prediction (CELP), and the compressed data is decompressed before being played back to the operator. In the text data format, the text data is read to the operator using a predetermined synthetic voice. Using the operational help information, the operator operates the interface device by pronouncing a keyword of a desired function, and the voice recognized keyword is searched in the operational help file to extract a corresponding group. The entire audio file for the extracted group is outputted for the first time to confirm what operational items are included in the extracted group. From a second time on, the audio information for one operational item is read at a time, and the operator instructs whether or not the operational item candidate is confirmed and whether or not a next operational item is described. For example, for the operational help for the structure as shown in FIG. 7, when “both sides” is pronounced as a keyword, the audio response includes the following:

“For specifying both sides, consolidation, and division.”

“1. Setting Original to be both sides.”

“2. Setting photocopying to both sides.”

“3. Setting Consolidation to both sides of four pages.”

“4. Setting Consolidation to both sides of eight pages.”

“5. Setting Division to both sides of right and left pages.”

In stead of reading one option at a time for selection, since each selection has a corresponding number, all of the selections are read at a time for a selection by the corresponding number. To select an option, the operator inputs a number of a desired option via the keypad or pronounces the corresponding number. Furthermore, after selecting and inputting values in the operational items, a confirm key # is pressed to list the currently selected operational items on the display screen of the operational unit. The operator sequentially moves among the operational items whose default value has been changed so that the values may be modified. Alternatively, a set of selected operational items and the values is stored on an IC card, and the set is named for a particular operation. In a subsequent operation, the named operation is specified to perform the corresponding operation by reading the specified set of the information from the IC card without actually inputting the same information.

(3) Feedback on the Operational Result to the Operator by Sound Icons and Background Music

In moving and selecting the operational items on the layered menu via the keypad, the current device notifies the operator of the operational results by the background music (BMG) and the sound icons. By notifying with a carefully selected and associated sound icon and BMG, the operator ascertains the current situation. The operator will have a least amount of worry for the completion of the action or the input. A variety of sound icons and BMG is associated with a corresponding one of the operational items, and the sound icon and the BMG are outputted to the headset when the current position is moved to a new operational item. Based upon the combination of the sound icon and the BMG, the operator confirms as to which operational item he or she has moved, and the BMG indicates whether or not the operational item has been confirmed. A pair of sound icons is provided for vertically moving up and down, and a corresponding one of the sound icons is outputted as the vertical move takes place. The pair of vertical movement sound icons is different from the above described sound icons for the operational items. The BMG is used to indicate an approximate layer to the operator. For example, as the current position reaches an upper layer, slower music is used. In contrast, as the current position reaches a lower layer, faster music is used. By outputting a certain sound icon, the operator is notified whether there is any operational item in a lower layer. If there is no operational item in a layer, the operator is notified by a certain sound icon that the lower movement is not allowed. Furthermore, certain other sound icons are used to indicate a number of operational items in a lower layer.

The use of the sound icons and BGM includes other situations. For a horizontal movement, a particular sound icon is similarly used to indicate that the current position has reached the end and no movement is allowed when a circular movement is not available. Another set of sound icons is correspondingly associated with other movements such as a jump to the top, a horizontal move and a direct move to a specified operational item for confirming each movement. The operator is assured of the movement by the output of the sound icon. Similarly, while a value such as a number of copies is being inputted, a certain BGM is outputted to confirm that a number is being accepted. By the same token, the use of certain BGM is associated with a particular state of the machine to which the interface device is applied. For example, the operator is notified by a corresponding sound icon for conditions such as “out of paper,” “low toner,” and “paper jam.” When these conditions are not immediately corrected, a corresponding BMG is outputted for a certain period of time or until the conditions are corrected. For example, if the operator is not near the machine during a photocopying job and a paper jam occurs, the sound icon alone is not sufficient to notify the operator. Thus, a particular BMG is outputted after a sound icon. Another use of BMG is to indicate the status of a particular on-going task such as photocopying. For example, during a 40-page copy job, BMG is played. The operator is notified of the completion status of the copy job by listening to a currently played portion of the BMG which indicates a corresponding progress. In other words, if the middle portion of the BMG is being played, the task is approximately 50% completed.

(4) Voice Feedback for Operational Result

When the operator moves and selects operational items in the layered menu by the keypad in the above described manner, the interface device according to the current invention outputs voice messages to the headset of the operator to confirm the operational results. The audio outputs assure the operational results and relieves the operator from any concerns. By providing a voice feedback on the predetermined content to identify each operational item upon a movement, the operator confirms the currently moved operational item. Upon the move, the voice feedback also provides the operator with information on whether or not the operational item exists in a lower layer and on how many operational items exist in the lower layer. For example, when the current position is moved to operational items such as “enlargement” and “114%,” the interface device reads out these items. A key 5 in the keypad provides a voice feedback on the predetermined content to identify each operational item upon a movement. The content information includes the operational item name and the function number. After the paper size is set to A4Side, pressing the key 5, the voice feedback reads “paper has been set to A4Side. After selecting an operational item, for example, a key # is pressed to confirm the selection via a voice message feedback. For example, the voice confirmation message reads “the enlargement is 200%” if the “enlargement” and “200%” have been selected and confirmed. Similarly, when a setting confirmation key is pressed to confirm the settings that have been already made, the interface device reads all of the operational items whose default values have been modified by the operator. In stead of reading all of the operational items at once, one operational item is read at a time for the operator to correct any error, and a next modified operational item is read when the operator presses a certain key. Finally, the key # is pressed to finally confirm the settings.

After every operational item has been specified and a key “START” is pressed, the interface device outputs a voice feedback upon completing the specified task under the operational setting. For example, the voice feedback on the results includes “copying has been completed with 122% enlargement” or “copying was not completed due to paper jamming.” In addition, during the operation and activation of the interface device according to the current invention, after the sound icon, the voice messages tell the operator “paper is out of paper,” “toner is low,” and “a front cover is open.” In the voice feedback, the volume, rhythm, tone and speed are varied so that the operator can understand easily. Before the voice feedback is completed, if the operator strikes a key for a next operation, the voice feedback automatically speeds up so that the operator feels less frustrated. By guided in the above described layered menu by sound and voice, the operator generally gets used to the interface device according to the current invention only after five minutes of practice. The display unit of the interface device according to the current invention almost simultaneously displays the operation results of the operator, and the selection process also allows the operator to input a selection through the touch-screen panel and the keypad in parallel. The parallel input mode enables an operator without disability to help an operator with disability. The parallel input mode also allows an operator with slight visual handicap to input data in the audio mode and the regular mode. For example, when the operator is at lost in the middle of operations, he or she can select an operational item via the touch panel with the help of another operator without disability. Since the sound icon and voice message for the new setting are outputted to the headphone, the operator with disability also knows what is selected.

(5) Exemplary Operations

One exemplary operation is illustrated for “setting a number of copies to two” using the interface device according to the current invention. Initially, by operating on the layered menu to move to “a number of copies,” following a first sound icon for the number of copies, a voice message explains the corresponding operational item. If the operator pressed the # key, following a sound icon, the voice message is outputted to the headphone, “please enter a number of copies via the keypad and press the # key.” Then, a particular BGM is played for inputting numerical values. When the operator presses a key 2 on the keypad, the operator hears the feedback message for the entered number through the headphone. Upon pressing the # key, following a second sound icon, the voice message reads “the number of copies has been set to two.” After pressing the start key, while the copying task is taking place, a particular BGM is played into the headset. Upon completing the copying task, the voice message says, “two copies have been completed.”

C. Functional Components

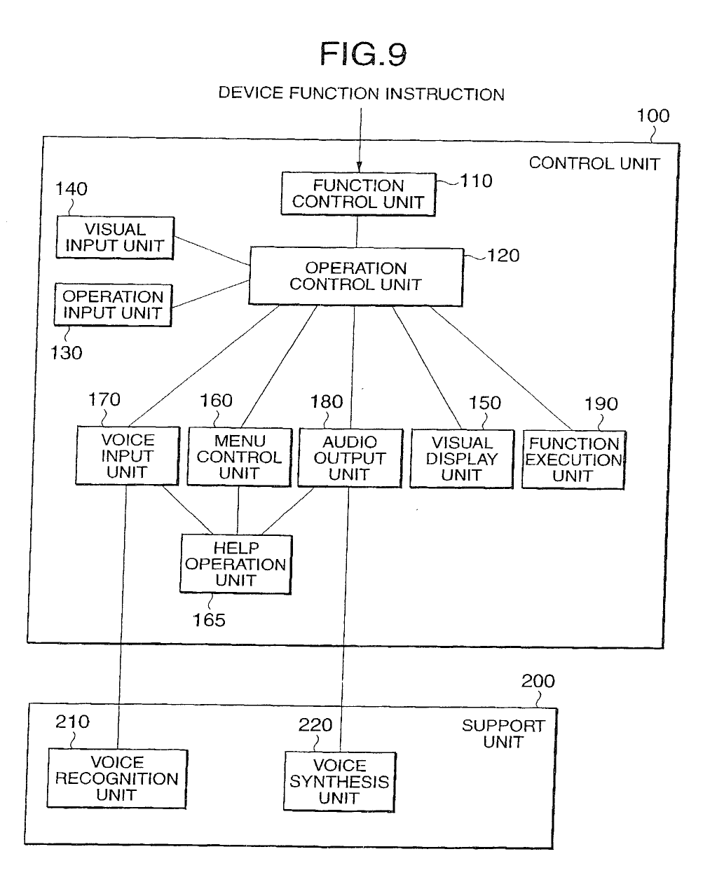

FIG. 9 is a block diagram that illustrates one preferred embodiment of the interface device according to the current invention. The interface device generally includes a control unit 100 for controlling the execution of tasks and a support unit 200 for performing voice recognition and voice synthesis based upon the instructions from the control unit 100. The control unit 100 further includes a function control unit 110, an operation control unit 120, an operation input unit 130, a visual input unit 140, a visual display unit 150, a menu control unit 160, a help operation unit 165, a voice or audio input unit 170, a voice or audio output unit 180, and a function execution unit 190. The function control unit 110 identifies if a user is a visually impaired person and determines either the regular mode or the audio mode is used. In response to a user selection for a photocopier or a facsimile machine, the function control unit 110 initializes the operational parameters and assumes the overall control. The operation control unit 120 controls various operational inputs from the operator and the display outputs of the corresponding operational results. The operation input unit 130 inputs numbers and son on from the keypad. In the audio mode, the keypad inputs are used to move, select and confirm operational items in the layered menu. The visual input unit 140 inputs the selection of various displayed operational items using the touch panel on the display screen in the normal mode. The visual input unit 140 is also used to select the operational items by the visually impaired as well as the operator without disability. The visual display unit 150 displays various functions on the display screen in the normal mode. The visual display unit 150 displays the selected and confirmed operational items on the display screen in the audio mode. The menu control unit 160 controls the current position in the layered menu based upon the voice inputs and the key inputs while the operator selects and confirms the operational items in the layered menu that corresponds to the selected function.

Still referring to FIG. 9, other units will be explained. In the audio mode, the voice input unit 170 requests the voice recognition unit 210 to perform voice recognition on the operation item name or function number that the operator has pronounced. The voice input unit 170 sends the voice recognition results from the voice recognition unit 210 to the menu control unit 160. When the operator pronounces a keyword in the audio mode, the voice input unit 170 requests the voice recognition unit 210 to perform voice recognition on the keyword and sends the voice recognition result to the help operation unit 165. The operator thus moves to a desired operational item in the layered menu. The help operation unit 165 searches the keyword form the voice input unit 170 in the operational help information file and extracts a group that corresponds to the keyword. For the first time, the voice information of the extracted group is read to confirm the existence of all operational items. From the second time on, one operational item is read at a time, and the operator responds to it by the confirmation key or the next candidate key. After hearing all of the operational items, the operator selects the desired operational items by inputting a corresponding item number through the keypad or by pronouncing the item number. The menu control unit 160 holds the current position of the confirmed operational item in the layered menu. In the audio mode, the audio output unit 180 outputs a sound icon, a voice guide message and BGM for indicating key operations and execution results in response to the menu control unit 160 and the operation control unit 120. In response to the help operation unit 165, the audio output unit 180 outputs the voice information for the keyword that the operator has pronounced. After various operational items have been specified, the function execution unit 190 executes the selected function such as a photocopier or a facsimile machine based upon the specified operational parameters.

The support unit 200 further includes a voice recognition unit 210 and a voice synthesis unit 220. The voice recognition unit 210 is activated by the voice input unit 170. Using a voice recognition dictionary for the function that the operator is currently operating, the voice recognition unit 210 ultimately returns to the voice input unit 170 the voice recognition results of the operator pronounced voice inputs such as operational item names and function numbers. One example of the voice recognition dictionary is the voice recognition dictionary for the photocopier. The voice synthesis unit 220 is activated by the audio output unit 180 and returns to the audio output unit 180 a synthesized voice signal from the text using a voice synthesis dictionary for the voice feedback to the operator.

The operation of the preferred embodiment of the user interface device according to the current invention will be described in relation to the operation for copying an original. After the operator inserts a jack of the headset having a microphone and earphones, the function control unit 110 determines that a visually impaired person uses the current interface device and switches to the audio mode. Alternatively, the preferred embodiment also recognizes the visually impaired person based upon a non-contact type IC card that identifies an individual with visual impairment and contains information such as past operational records. Furthermore, one additional recognition method is that the visually impaired person presses a predetermined special key to indicate the use by the visually impaired. After pressing a function key to select a desired function such as photocopying, faxing, printing, scanning or net filing, the function control unit 110 determines the device function to be utilized by the operator, extracts the corresponding layered menu data and initializes the layered menu data. The operator uses the keypad to move vertically among the layers or horizontally with in the same layer, and operation input unit 130 controls the input via the keypad. The operation control unit 120 keeps track of the position in the layered menu by sending the above keypad input information such as a numerical value to the menu control unit 160. Furthermore, upon the input, the operation control unit 120 activates the audio output unit 180 to outputs a sound icon, a voice message for reading the newly moved operational item by the key input and the corresponding BGM. The voice message is an operational item name that is synthesized by the voice synthesis unit 220.

When the operator moves downward to a lower layer in the layered menu and the lower layer has a plurality of the operational items, the menu control unit 160 moves to a particular one of the operational items according to one of the following predetermined rules. A first predetermined rule is to go to a first operational item in the lower layer. A second predetermined rule is to go to a previously entered value or previously selected item in the lower layer. A third movement is to go to a predetermined default operational item in the lower layer. Upon completing the downward movement, the menu control unit 160 activates the audio output unit 180 to output a sound icon, a BGM and the voice output for the operational item name in order to notify the operator of the complete operation. Furthermore, upon the horizontal movement to another operational item in the same layer, the menu control unit 160 keeps track of the current position in the layered menu. For example, in a circular movement among the operational items, upon reaching an end operational item at one end in the layer, the menu control unit 160 keeps track of a next operational item to be the other end. When the above circular movement is not used, after reaching an end operational item at one end in the layer, the menu control unit 160 holds the current position after further attempts to move. In the above case, the menu control unit 160 activates the audio output unit 180 to output a sound icon so as to notify the operator of the dead end.

The menu control 160 takes care of the following special key situations. When the operator presses the key 1 to go to the top of the layered menu, the menu control unit 160 stores the already selected operational items and keeps the top layer of the layered menu as the current position. During the jump movement, the menu control unit 160 activates the audio output unit 180 to output a sound icon and the voice output for the operational item name of the top layer in order to notify the operator of the completed operation. When the operator presses the key 0 to directly go to a desired operational item in the layered menu, the menu control unit 160 activates the audio output unit 180 to output a sound icon, BGM and the voice message, “please enter a function number.” While the BGM is being played, the operator inputs a numerical value via the keypad. The audio output unit 180 outputs the inputted number in an audio message. When the operator presses the key #, the menu control unit 160 stops the BGM and outputs a sound icon and a voice message for reading the operational item name that corresponds to the already inputted function number. The operational item is kept as the current position. For example, after pressing the key 0 and inputting the number, “435,” the audio output unit 180 outputs a voice feedback message, “the reduction 71% has been set.” When the operator presses the key 5 to request for a current position in the layered menu, the menu control unit 160 activates the audio output unit 180 to notify the operator of the operational item name and the function number by a sound icon and a voice message.

The menu control 160 also takes care of the following special key situations. Similarly, when the operator presses the key 9 to request for a current position in the layered menu, the menu control unit 160 activates the audio output unit 180 to output a sound icon and a voice message, “please say an operational item name, a function number or a keyword.” Subsequently, the menu control unit 160 activates the voice input unit 170 before the operator pronounces an operational item name, a function number or a keyword, and the voice recognition unit 210 performs the voice recognition on the voice input. If the voice recognition result is either a function number or an operational item number, the menu control unit 160 keeps the corresponding operational item as the current position. The menu control unit 160 activates the audio output unit 180 to output a sound icon and a voice message on the corresponding operational item name to notify the operator of the correct voice recognition. On the other hand, if the voice recognition result is neither a function number nor an operational item number, the menu control unit 160 searches an operational item in the layered menu. If the search result is a single operational item, the searched operational item is kept as the current position. The menu control unit 160 activates the audio output unit 180 to output a sound icon and a voice message on the corresponding operational item name to notify the operator of the completed voice recognition. When the above voice recognition yields neither of the above described two results, the menu control unit 160 treats the voice recognition result as a keyword and activates the help operation unit 165. The help operation unit 165 searches the voice recognized keyword in the help information file and extracts a group corresponding to the keyword. The audio output unit 180 initially outputs the voice message to read every operational item in the extracted group for confirmation. If the voice information is in a text format, the voice synthesis unit 220 converts the voice information into voice messages before outputting. The help operation unit 165 subsequently reads one operational item at a time, and the operator instructs whether to confirm the operation item or to move to a next operational item.

When the operator presses the key # to confirm the selection of the operational items, the menu control unit 160 activates the audio output unit 180 to notify the operator by a sound icon and a voice message on the confirmed operation. Furthermore, the menu control unit 160 activates the visual display unit 150 to display on the screen the confirmed operational item contents. When the operator presses the confirmation key to find out which operational items have been selected, the menu control unit 160 notifies the operator of the operational items whose default values have been modified by outputting one voice message at a time for the modified operational item through the audio output unit 180. The menu control unit 160 keeps the moved destination as the current position and allows the user to correct any error in the operational item.

Still referring to FIG. 9, the function control unit 110 observes the status of the preferred embodiment during the operation. For example, in case of certain conditions such as out of paper, low toner, paper jam and open front cover, the function control unit 110 activates the audio output unit 180 to notify the operator by outputting a sound icon, a BGM and a corresponding voice message such as “paper is out,” “toner is low,” “paper is jammed,” or “the front cover is open.” After completing the setting of the operational items and the operator presses the start key, the operation control unit 120 calls the function execution unit 190 to activate the user selected function. For example, if the user selected function is photocopying, photocopying takes place according to the specified operational parameters. After the copying operation ends, the operation control unit 120 activates the audio output unit 180 to notify the operator of the completion status by a voice message. The exemplary voice feedback messages include “copying is completed at 122% enlargement” and “copying is incomplete due to paper jamming.” The operation control unit 120 plays a BGM via the audio output unit 180 to indicate a progress in the current task such as making forty copies, and the operator understands an approximate progress based upon the BGM.

D. Other Preferred Embodiments

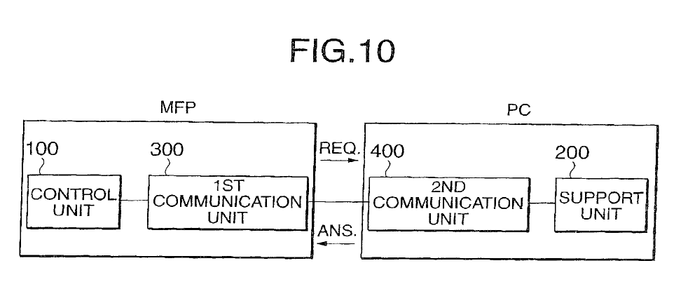

In the above described preferred embodiment according to the current invention, the interface device includes both the control unit 100 and the support unit 200, and the combined units are incorporated into the MFP. Now referring to FIG. 10, in a second preferred embodiment, the control unit 100 is incorporated in the MFP while the support unit 200 is incorporated in a personal computer 100. In the second preferred embodiment, a first communication unit 300 in the MFP and a second communication unit 400 in the PC take care of the communication between the control unit 100 and the support unit 200 via cable or network. The control unit 100 and the support unit 200 as shown in FIG. 10 respectively include all the components or units as described with respect to FIG. 9, and the description of each of these components in the control unit 100 and the support unit 200 is not reiterated here.

In the above described configuration, when voice recognition takes place in response to the control unit 100, key information indicating a request for voice recognition and the input voice information from the voice input unit 170 are sent to the second communication unit 400 via the first communication unit 300. In response to the key information, the second communication unit 400 activates the voice recognition unit 210 to generate the voice recognition result. The second communication unit 400 adds the key information to the voice recognition result and returns the combined data to the first communication unit 300. The control unit 100 in turn determines the received data as the voice recognition result based upon the key information and returns the voice recognition data to the voice input unit 170. Similarly, when voice synthesis takes place in response to the control unit 100, key information indicating a request for voice synthesis and the text data to be converted to voice synthesis data from the voice output unit 180 are sent to the second communication unit 400 via the first communication unit 300. In response to the key information, the second communication unit 400 activates the voice synthesis unit 220 to generate the voice synthesis result. The second communication unit 400 adds the key information to the voice synthesis result and returns the combined data to the first communication unit 300. The control unit 100 in turn determines the received data as the voice synthesis result based upon the key information and returns the voice synthesis data to the voice output unit 180.

As described above, by dividing the functions between the MFP and the PC, the MFP is advantageously free from having the support unit 200 that includes a large volume of data such as in dictionaries and performs time consuming processes such as the voice recognition and the voice synthesis. Furthermore, it is easier to perform the maintenance of the dictionaries in the support unit and the maintenance of the PC. It is also cost effective to connect multiple MFP's to a single PC for the support.

E. Preferred Embodiments in Software Program

The functions of the above described preferred embodiments are implemented in software programs that are stored in recording media such as a CD-ROM. The software in the CD is read by a CD drive into memory of a computer or another storage medium. The recording media include semiconductor memory such as read only memory (ROM) and involatile memory cards, optical media such as DVD, MO, MD or CD-R and magnetic media such as magnetic tape and floppy disks. The above software implementation also accomplishes the purposes and objectives of the current invention. In the software implementation, the software program itself is a preferred embodiment. In addition, a recording medium that stores the software program is also considered as a preferred embodiment.

The software implementation includes the execution of the program instructions and other routines such as the operating system routines that are called by the software program for processing a part or an entire process. In another preferred embodiment, the above described software program is loaded into a memory unit of a function expansion board or a function expansion unit. The CPU on the function expansion board or the function expansion unit executes the software program to perform a partial process or an entire process to implement the above described functions.

Furthermore, the above described software program is stored in a storage device such as a magnetic disk in a computer server, and the software program is distributed by downloading to a user in the network. In this regard, the computer server is also considered to be a storage medium according to the current invention.

F. Preferred Process of Interfacing Visually Impaired Operator with MFP

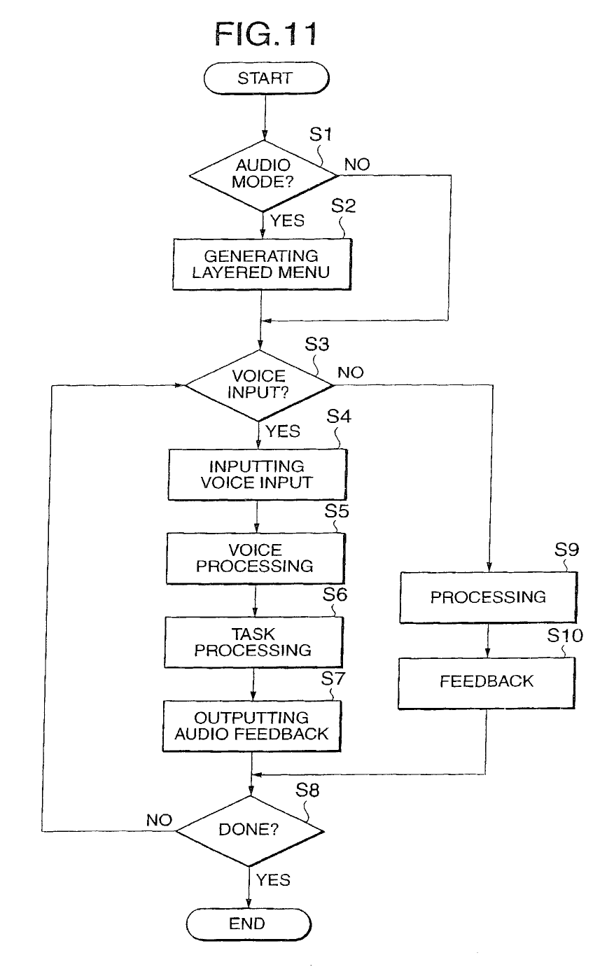

Now referring to FIG. 11, a flow chart illustrates steps involved in a preferred process of interfacing a visually impaired operator with a MFP according to the current invention. In a step 1, a preferred embodiment of the interface device according to the current invention detects and determines the use of the MFP by a predetermined group of people such as visually impaired operators. If it is determined that the use is by the visually impaired in the step 1, the preferred process generates the above described layered menu containing a predetermined set of operational items in the tree structure and initializes certain operational items in a step 2. If it is determined that the use is not by the visually impaired in the step 1, the preferred process fails to generate the above described layered menu and proceeds to a step 3. Each input is determined whether or not a voice input from the visually impaired operator in the step 3. If it is determined that the input is a non-voice input such as entered via a keypad in the step 3, the preferred process performs the steps 9, 10 where the input is respectively processed and its feedback is provided. On the other hand, if it is determined in the step 3 that the input is a voice input such as an operational item name that is pronounced by the operator, the preferred process proceeds to a step S4 where the voice input is inputted for further processing. The voice input undergoes a voice recognition step in a step S5 to generate a voice recognition result. Based upon the voice recognition result, a corresponding task is performed in a step S6. One example task is to move the current position to the specified operational item in the layered menu. Another example is to search the voice recognition result in a help information file. Immediately following the step S6, the status of the performed task is provided by an audio feedback such as a descriptive message, a sound icon or BMG in a step S7. Regardless of the original input, the preferred process determines in a step S8 whether or not a current session has been completed. If the current session is not yet over, the preferred process returns to the step S3. If the current session is complete, the preferred process terminates itself.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of interfacing a visually impaired with a multi function machine, the multi function machine having an audio operation mode and a normal operation mode, comprising the steps of:
identifying a use of the multi function machine by the visually impaired;
switching an operational mode of the multi function machine from the normal operation mode to the audio operation mode upon identifying the use by the visually impaired;
generating a layered menu having multiple layers, each layer having a predetermine number of operational items;
receiving a voice input with respect to the layered menu from the visually impaired in the audio operation mode; and
responding to the voice input by an audio feedback to the visually impaired.

2. The method of interfacing a visually impaired with a multi function machine according to claim 1 where the voice input is a movement command to move to a certain location with in the layered menu.

3. The method of interfacing a visually impaired with a multi function machine according to claim 2 where the movement command is to move with in one of the multiple layers.

4. The method of interfacing a visually impaired with a multi function machine according to claim 2 where the movement command is to move between the multiple layers.

5. The method of interfacing a visually impaired with a multi function machine according to claim 2 where the audio feedback outputs names of the operational items.

6. The method of interfacing a visually impaired with a multi function machine according to claim 5 wherein the names of operational items are outputted all at once.

7. The method of interfacing a visually impaired with a multi function machine according to claim 5 wherein one of the names of operational items is outputted at a time.

8. The method of interfacing a visually impaired with a multi function machine according to claim 1 where the voice input is a selection command to select one of the operational items.

9. The method of interfacing a visually impaired with a multi function machine according to claim 8 where the audio feedback outputs a name of the selected one of the operational items.

10. The method of interfacing a visually impaired with a multi function machine according to claim 8 where the voice input is a confirmation command to confirm the selected one of the operational items.

11. The method of interfacing a visually impaired with a multi function machine according to claim 10 where the audio feedback outputs a name of the selected one of the operational items.

12. The method of interfacing a visually impaired with a multi function machine according to claim 1 where the voice input is a keyword to be searched.

13. The method of interfacing a visually impaired with a multi function machine according to claim 12 where the audio feedback outputs a search result of the keyword.

14. The method of interfacing a visually impaired with a multi function machine according to claim 13 where the search result is help information.

15. The method of interfacing a visually impaired with a multi function machine according to claim 1 where the audio feedback includes a sound icon, a voice message and background music.

16. The method of interfacing a visually impaired with a multi function machine according to claim 15 where the voice message is outputted at a predetermined pitch based upon a corresponding predetermined condition.

17. The method of interfacing a visually impaired with a multi function machine according to claim 15 where the voice message is outputted at a predetermined speed based upon a corresponding predetermined condition.

18. The method of interfacing a visually impaired with a multi function machine according to claim 15 where the background music is outputted at a predetermined speed based upon a corresponding predetermined condition.

19. The method of interfacing a visually impaired with a multi function machine according to claim 1 where the use of the multi function machine by the visually impaired is identified by reading a non-contact IC card near the multi function machine.

20. The method of interfacing a visually impaired with a multi function machine according to claim 1 where the use of the multi function machine by the visually impaired is identified by inserting a headset into the multi function machine.

21. An interface device for interfacing a visually impaired with a multi function machine, the multi function machine having an audio operation mode and a normal operation mode, comprising:
a function control unit for identifying a use of the multi function machine by the visually impaired and for switching an operational mode of the multi function machine from the normal operation mode to the audio operation mode upon identifying the use by the visually impaired;
an operational control unit connected to said function unit for controlling a user input and a user output based upon the operational mode;
a voice input unit connected to said operational unit for inputting a voice input as the user input with respect to the layered menu in the audio operation mode;
a menu control unit connected to said operational control unit for tracking a current position in a layered menu having multiple layers based upon the user input, each layer having a predetermine number of operational items; and
a voice output unit connected to said operational unit for outputting an audio feedback in response to the user input.

22. The interface device for interfacing a visually impaired with a multi function machine according to claim 21 where the voice input is a movement command to move to a certain location with in the layered menu.

23. The interface device for interfacing a visually impaired with a multi function machine according to claim 22 where the movement command is to move with in one of the multiple layers.

24. The interface device for interfacing a visually impaired with a multi function machine according to claim 22 where the movement command is to move between the multiple layers.

25. The interface device for interfacing a visually impaired with a multi function machine according to claim 22 where the audio feedback outputs names of the operational items.

26. The interface device for interfacing a visually impaired with a multi function machine according to claim 25 wherein the names of operational items are outputted all at once.

27. The interface device for interfacing a visually impaired with a multi function machine according to claim 25 wherein one of the names of operational items is outputted at a time.

28. The interface device for interfacing a visually impaired with a multi function machine according to claim 21 where the voice input is a selection command to select one of the operational items.

29. The interface device for interfacing a visually impaired with a multi function machine according to claim 28 where the audio feedback outputs a name of the selected one of the operational items.

30. The interface device for interfacing a visually impaired with a multi function machine according to claim 28 where the voice input is a confirmation command to confirm the selected one of the operational items.

31. The interface device for interfacing a visually impaired with a multi function machine according to claim 30 where the audio feedback outputs a name of the selected one of the operational items.

32. The interface device for interfacing a visually impaired with a multi function machine according to claim 21 where the voice input is a keyword to be searched.

33. The interface device for interfacing a visually impaired with a multi function machine according to claim 32 where the audio feedback outputs a search result of the keyword.

34. The interface device for interfacing a visually impaired with a multi function machine according to claim 33 where the search result is help information.

35. The interface device for interfacing a visually impaired with a multi function machine according to claim 21 where the audio feedback includes a sound icon, a voice message and background music.

36. The interface device for interfacing a visually impaired with a multi function machine according to claim 35 where the voice message is outputted at a predetermined pitch based upon a corresponding predetermined condition.

37. The interface device for interfacing a visually impaired with a multi function machine according to claim 35 where the voice message is outputted at a predetermined speed based upon a corresponding predetermined condition.

38. The interface device for interfacing a visually impaired with a multi function machine according to claim 35 where the background music is outputted at a predetermined speed based upon a corresponding predetermined condition.

39. The interface device for interfacing a visually impaired with a multi function machine according to claim 21 where the use of the multi function machine by the visually impaired is identified by reading a non-contact IC card near the multi function machine.

40. The interface device for interfacing a visually impaired with a multi function machine according to claim 21 where the use of the multi function machine by the visually impaired is identified by inserting a headset into the multi function machine.

41. The interface device for interfacing a visually impaired with a multi function machine according to claim 21 further comprising:
a visual input unit connected to said operational control unit for inputting the user input by touching a predetermined surface area; and
a visual display unit connected to said operational control unit for displaying the user output.

42. The interface device for interfacing a visually impaired with a multi function machine according to claim 21 further comprising:
a voice recognition unit connected to said voice input unit for recognizing the voice input to generate a search keyword; and
a help operation unit connected to said voice input unit and said voice output unit for searching the keyword in a predetermined help file to generate searched data and for outputting the searched data to said voice output unit.

43. The interface device for interfacing a visually impaired with a multi function machine according to claim 42 further comprising a voice synthesis unit connected to said voice output unit for synthesizing a voice output signal based upon the searched data.

44. A recording medium for storing computer instructions for interfacing a visually impaired with a multi function machine, the multi function machine having an audio operation mode and a normal operation mode, the computer instructions performing the tasks of:
generating a layered menu having multiple layers, each layer having a predetermine number of operational items;
identifying a use of the multi function machine by the visually impaired;
switching an operational mode of the multi function machine from the normal operation mode to the audio operation mode upon identifying the use by the visually impaired;
receiving a voice input with respect to the layered menu from the visually impaired in the audio operation mode; and
responding to the voice input by an audio feedback to the visually impaired.

45. The recording medium for storing computer instructions according to claim 44 where the voice input is a movement command to move to a certain location with in the layered menu.

46. The recording medium for storing computer instructions according to claim 45 where the audio feedback outputs names of the operational items.

47. The recording medium for storing computer instructions according to claim 44 where the voice input is a selection command to select one of the operational items.

48. The method of interfacing a visually impaired with a multi function machine according to claim 47 where the audio feedback outputs a name of the selected one of the operational items.

49. The recording medium for storing computer instructions according to claim 44 where the voice input is a keyword to be searched.

50. The recording medium for storing computer instructions according to claim 49 where the audio feedback outputs a search result of the keyword.

51. The recording medium for storing computer instructions according to claim 44 where the audio feedback includes a sound icon, a voice message and background music.

52. The recording medium for storing computer instructions according to claim 51 where the voice message is outputted at a predetermined pitch based upon a corresponding predetermined condition.

53. The recording medium for storing computer instructions according to claim 51 where the voice message is outputted at a predetermined speed based upon a corresponding predetermined condition.

54. The recording medium for storing computer instructions according to claim 51 where the background music is outputted at a predetermined speed based upon a corresponding predetermined condition.
